(19) United States
(12) Patent Application Publication
(10) Pub. No.: US 2024/0340908 A1
(43) Pub. Date: Oct. 10, 2024

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Yanan LIN, Dongguan (CN); Yi ZHANG, Dongguan (CN); Jing XU, Dongguan (CN)

(21) Appl. No.: 18/748,518

(22) Filed: Jun. 20, 2024

Related U.S. Application Data
(63) Continuation of application No. PCT/CN2021/143046, filed on Dec. 30, 2021.

(51) Int. Cl. H04W 72/21; H04L 1/1812

(52) U.S. Cl. CPC H04W 72/21; H04L 1/1812

(57) ABSTRACT

A wireless communication method, a terminal device, and a network device are provided. The wireless communication method includes the following. A terminal device receives first information. The first information indicates that a first feedback codebook is to be transmitted in a first time unit, the first feedback codebook contains feedback information in a second feedback codebook, and the second feedback codebook is to be transmitted in a second time unit. The second time unit overlaps with the first time unit, or a time domain resource occupied by a physical uplink control channel (PUCCH) carrying the second feedback codebook overlaps with the first time unit, or the PUCCH carrying the second feedback codebook overlaps a PUCCH carrying the first feedback codebook.

### CROSS-REFERENCE TO RELATED APPLICATION(S)

This application is a continuation of International Application No. PCT/CN2021/143046, filed Dec. 30, 2021, the entire disclosure of which is incorporated herein by reference.

### TECHNICAL FIELD

Embodiments of the disclosure relate to the field of communication, and more particularly, to a wireless communication method, a terminal device, and a network device.

### BACKGROUND

A new radio (NR) system supports multiple types of hybrid automatic repeat request-acknowledgement (HARQ-ACK) feedback codebooks, which include a Type-1 codebook, a Type-2 codebook, a Type-3 codebook, and an enhanced Type-3 (eType-3) codebook. However, if a Type-3/eType-3 codebook and a Type-1/Type-2 codebook are configured to be transmitted in the same time unit, how to perform HARQ-ACK feedback is a problem to be solved.

### SUMMARY

In a first aspect, a wireless communication method is provided. The method includes the following. A terminal device receives first information. The first information indicates that a first feedback codebook is to be transmitted in a first time unit, the first feedback codebook contains feedback information in a second feedback codebook, and the second feedback codebook is to be transmitted in a second time unit. The second time unit overlaps with the first time unit, or a time domain resource occupied by a physical uplink control channel (PUCCH) carrying the second feedback codebook overlaps with the first time unit, or the PUCCH carrying the second feedback codebook overlaps with a PUCCH carrying the first feedback codebook.

In a second aspect, a network device is provided. The network device includes a transceiver, a processor and a memory. The memory is configured to store computer programs. The processor is configured invoke and execute the computer programs stored in the memory, so as to: cause the transceiver to send first information to a terminal device. The first information indicates that a first feedback codebook is to be transmitted in a first time unit, the first feedback codebook contains feedback information in a second feedback codebook, and the second feedback codebook is to be transmitted in a second time unit. The second time unit overlaps with the first time unit, or a time domain resource occupied by a PUCCH carrying the second feedback codebook overlaps with the first time unit, or the PUCCH carrying the second feedback codebook overlaps with a PUCCH carrying the first feedback codebook.

In a third aspect, a terminal device is provided. The terminal device includes a transceiver, a processor and a memory. The memory is configured to store computer programs. The processor is configured invoke and execute the computer programs stored in the memory, so as to perform the method described above in the first aspect.

### BRIEF DESCRIPTION OF THE DRAWINGS

FIG. 1 is a schematic architectural diagram of a communication system to which embodiments of the disclosure are applied.

FIG. 2 is a schematic diagram illustrating a structure of a Type-3 hybrid automatic repeat request-acknowledgement (HARQ-ACK) codebook provided in the disclosure.

FIG. 3 is a schematic diagram illustrating transmission of a low priority (LP) enhanced Type-3 (eType-3) codebook and a high priority (HP) Type-2 codebook provided in the disclosure.

FIG. 4 is a schematic interaction flowchart of a wireless communication method provided in embodiments of the disclosure.

FIG. 5 is a schematic diagram illustrating transmission of a Type-2 codebook and an eType-3 codebook provided in embodiments of the disclosure.

FIG. 6 is a schematic diagram illustrating another transmission of a Type-2 codebook and an eType-3 codebook provided in embodiments of the disclosure.

FIG. 7 is a schematic diagram illustrating transmission of feedback information provided in embodiments of the disclosure.

FIG. 8 is a schematic block diagram of a terminal device provided in embodiments of the disclosure.

FIG. 9 is a schematic block diagram of a network device provided in embodiments of the disclosure.

FIG. 10 is a schematic block diagram of a communication device provided in embodiments of the disclosure.

FIG. 11 is a schematic block diagram of an apparatus provided in embodiments of the disclosure.

FIG. 12 is a schematic block diagram of a communication system provided in embodiments of the disclosure.

### DETAILED DESCRIPTION

The following will describe technical solutions of embodiments of the disclosure with reference to the accompanying drawings in embodiments of the disclosure. Apparently, embodiments described herein are merely some embodiments, rather than all embodiments, of the disclosure. Based on the embodiments of the disclosure, all other embodiments obtained by those of ordinary skill in the art without creative effort shall fall within the protection scope of the disclosure.

The technical solutions of embodiments of the disclosure are applicable to various communication systems, for example, a global system of mobile communication (GSM), a code division multiple access (CDMA) system, a wideband code division multiple access (WCDMA) system, a general packet radio service (GPRS), a long term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), an Internet of things (IoT), a wireless fidelity (WiFi), a 5^{th}-generation (5G) communication system, or other communication systems, etc.

Generally speaking, a conventional communication system generally supports a limited quantity of connections and therefore is easy to implement. However, with development of communication technology, a mobile communication system will not only support conventional communication but also support, for example, device to device (D2D) communication, machine to machine (M2M) communication, machine type communication (MTC), vehicle to vehicle (V2V) communication, or vehicle to everything (V2X) communication, etc. Embodiments of the disclosure can also be applied to these communication systems.

In some embodiments, the communication system in embodiments of the disclosure may be applied to a carrier aggregation (CA) scenario, or may be applied to a dual connectivity (DC) scenario, or may be applied to a standalone (SA) network deployment scenario, or may be applied to a non-standalone (NSA) network deployment scenario.

In some embodiments, the communication system in embodiments of the disclosure is applicable to an unlicensed spectrum, and an unlicensed spectrum may be regarded as a shared spectrum. Alternatively, the communication system in embodiments of the disclosure is applicable to a licensed spectrum, and a licensed spectrum may be regarded as a non-shared spectrum.

In some embodiments, the communication system in embodiments of the disclosure may be applied to a frequency range 1 (FR1) frequency band (corresponding to a frequency range of 410 megahertz (MHZ) to 7.125 gigahertz (GHz)), or may be applied to an FR2 frequency band (corresponding to a frequency range of 24.25 GHz to 52.6 GHZ), or may be applied to a new frequency band, for example, a high frequency band corresponding to a frequency range of 52.6 GHz to 71 GHz or a frequency range of 71 GHz to 114.25 GHz.

Various embodiments of the disclosure are described in connection with a network device and a terminal device. The terminal device may also be referred to as a user equipment (UE), an access terminal, a subscriber unit, a subscriber station, a mobile station, a remote station, a remote terminal, a mobile device, a user terminal, a terminal, a wireless communication device, a user agent, or a user device, etc.

The terminal device may be a station (ST) in a WLAN, a cellular radio telephone, a cordless telephone, a session initiation protocol (SIP) telephone, a wireless local loop (WLL) station, a personal digital assistant (PDA), various devices with wireless communication functions such as a handheld device or a computing device, other processing devices coupled with a wireless modem, an in-vehicle device, a wearable device, and a terminal device in a next-generation communication system, for example, a terminal device in an NR network, or a terminal device in a future evolved public land mobile network (PLMN), etc.

In embodiments of the disclosure, the terminal device may be deployed on land, which includes indoor or outdoor, handheld, wearable, or in-vehicle. The terminal device may also be deployed on water (such as ships, etc.). The terminal device may also be deployed in the air (such as airplanes, balloons, satellites, etc.).

In embodiments of the disclosure, the terminal device may be a mobile phone, a pad, a computer with wireless transceiver functions, a virtual reality (VR) terminal device, an augmented reality (AR) terminal device, a wireless terminal device in industrial control, a wireless terminal device in self driving, a wireless terminal device in remote medicine, a wireless terminal device in smart grid, a wireless terminal device in transportation safety, a wireless terminal device in smart city or a wireless terminal device in smart home, an in-vehicle communication device, a wireless communication chip/application specific integrated circuit (ASIC)/system on chip (SoC), etc.

By way of explanation rather than limitation, in embodiments of the disclosure, the terminal device may also be a wearable device. The wearable device may also be called a wearable smart device, which is a generic term of wearable devices obtained through intelligentization design and development on daily wearing products with wearable technology, for example, glasses, gloves, watches, clothes, accessories, and shoes. The wearable device is a portable device that can be directly worn or integrated into clothes or accessories of a user. In addition to being a hardware device, the wearable device can also realize various functions through software support, data interaction, and cloud interaction. A wearable smart device in a broad sense includes, for example, a smart watch or smart glasses with complete functions and large sizes and capable of realizing independently all or part of functions of a smart phone, and for example, various types of smart bands and smart jewelries for physical monitoring, of which each is dedicated to application functions of a certain type and required to be used together with other devices such as a smart phone.

In embodiments of the disclosure, the network device may be a device configured to communicate with a mobile device, and the network device may be an access point (AP) in a WLAN, a base transceiver station (BTS) in GSM or CDMA, or may be a Node B (NB) in WCDMA, or may be an evolutional Node B (eNB or eNodeB) in LTE, or a relay station or AP, or an in-vehicle device, a wearable device, a network device or base station (gNB) in an NR network, a network device in a future evolved PLMN, or a network device in an NTN, etc.

By way of explanation rather than limitation, in embodiments of the disclosure, the network device may be mobile. For example, the network device may be a mobile device. In some embodiments, the network device may be a satellite or a balloon base station. For example, the satellite may be a low earth orbit (LEO) satellite, a medium earth orbit (MEO) satellite, a geostationary earth orbit (GEO) satellite, a high elliptical orbit (HEO) satellite, etc. In some embodiments, the network device may also be a base station deployed on land or water.

In embodiments of the disclosure, the network device serves a cell, and the terminal device communicates with the network device on a transmission resource (for example, a frequency-domain resource or a spectrum resource) for the cell. The cell may be a cell corresponding to the network device (for example, a base station). The cell may belong to a macro base station, or may belong to a base station corresponding to a small cell. The small cell may include: a metro cell, a micro cell, a pico cell, a femto cell, and the like. These small cells are characterized by small coverage and low transmission power and are adapted to provide data transmission service with high-rate.

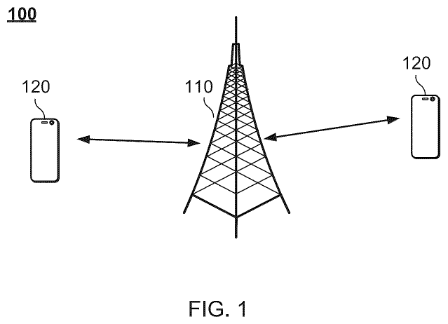

Exemplarily, FIG. 1 illustrates a communication system 100 to which embodiments of the disclosure are applied. The communication system 100 may include a network device 110. The network device 110 may be a device for communicating with a terminal device 120 (also referred to as “communication terminal” or “terminal”). The network device 110 can provide a communication coverage for a specific geographical area and communicate with terminal devices in the coverage area.

FIG. 1 exemplarily illustrates one network device and two terminal devices. In some embodiments, the communication system 100 may also include multiple network devices, and there can be other quantities of terminal devices in a coverage area of each of the network devices. Embodiments of the disclosure are not limited in this regard.

In some embodiments, the communication system 100 may further include other network entities such as a network controller, a mobility management entity, or the like, and embodiments of the disclosure are not limited in this regard.

It should be understood that, in embodiments of the disclosure, a device with communication functions in a network/system can be referred to as a “communication device”. Taking the communication system 100 illustrated in FIG. 1 as an example, the communication device may include the network device 110 and the terminal device(s) 120 that have communication functions. The network device 110 and the terminal device(s) 120 can be the devices described above and will not be elaborated again herein. The communication device may further include other devices such as a network controller, a mobility management entity, or other network entities in the communication system 100, and embodiments of the disclosure are not limited in this regard.

It should be understood that, the terms “system” and “network” herein are usually used interchangeably throughout this disclosure. The term “and/or” herein only describes an association between associated objects, which means that there can be three relationships. For example, A and/or B can mean A alone, both A and B exist, and B alone. In addition, the character “/” herein generally indicates that the associated objects are in an “or” relationship.

It should be understood that, the disclosure relates to a first communication device and a second communication device. The first communication device may be a terminal device, such as a mobile phone, a machine facility, a customer premise equipment (CPE), an industrial device, or a vehicle. The second communication device may be a peer communication device of the first communication device, such as a network device, a mobile phone, an industrial device, or a vehicle. Exemplarily, for the convenience of illustration, the first communication device is a terminal device and the second communication device is a network device.

Terms used in implementations of the disclosure are merely intended for explaining embodiments of the disclosure rather than limiting the disclosure. The terms “first”, “second”, “third”, “fourth”, and the like used in the specification, the claims, and the accompany drawings of the disclosure are used to distinguish different objects rather than describe a particular order. In addition, the terms “include”, “comprise”, and “have” as well as variations thereof are intended to cover non-exclusive inclusion.

It should be understood that, “indication” referred to in embodiments of the disclosure may be a direct indication, may be an indirect indication, or may mean that there is an association. For example, A indicates B may mean that A directly indicates B, for instance, B can be obtained according to A; may mean that A indirectly indicates B, for instance, A indicates C, and B can be obtained according to C; or may mean that that there is an association between A and B.

In the elaboration of embodiments of the disclosure, the term “correspondence” may mean that there is a direct or indirect correspondence between the two, may mean that there is an association between the two, or may mean a relationship of indicating and indicated or configuring and configured, etc.

In embodiments of the disclosure, the “predefined” or “preconfigured” can be implemented by pre-storing a corresponding code or table in a device (for example, including the terminal device and the network device) or in other manners that can be used for indicating related information, and the disclosure is not limited in this regard. For example, the “predefined” may mean defined in a protocol.

In embodiments of the disclosure, the “protocol” may refer to a communication standard protocol, which may include, for example, an LTE protocol, an NR protocol, and a protocol applied to a future communication system, and the disclosure is not limited in this regard.

In order for better understanding of technical solutions of embodiments of the disclosure, the technical solutions of the disclosure will be described in detail below in connection with embodiments. The following related art as an optional scheme can be arbitrarily combined with the technical solutions of embodiments of the disclosure, which shall all belong to the protection scope of embodiments of the disclosure. Embodiments of the disclosure include at least some of the following.

An NR system supports two schemes for generating acknowledgement (ACK)/negative ACK (NACK) information: a Type-1 feedback codebook (namely, a semi-static HARQ-ACK codebook) and a Type-2 feedback codebook (namely, a dynamic HARQ-ACK codebook). In the Type-1 feedback codebook, the number of bits in ACK/NACK feedback information corresponding to a physical downlink shared channel (PDSCH) is determined semi-statically, that is, the number of ACK/NACK bits in the feedback codebook does not depend on the number of PDSCHs actually received but is determined according to semi-statically configured downlink resources available for PDSCH transmission (namely, the maximum number of PDSCHs that can be received). The Type-2 feedback codebook is mainly intended for solving the problem of feedback overhead, that is, the amount of ACK/NACK information is determined according to the number of PDSCHs actually scheduled.

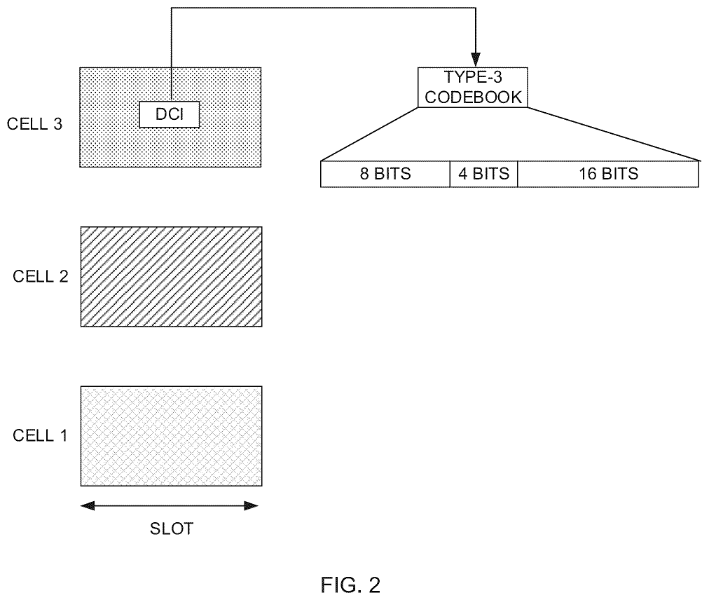

In addition, the NR system supports a scheme for ACK/NACK feedback for all HARQ processes, i.e. a Type-3 HARQ-ACK codebook is adopted for transmitting ACK/NACK feedback information. Specifically, a terminal supports up to NHARQ processes. If a base station sends downlink control information (DCI) to trigger the terminal to transmit a Type-3 HARQ-ACK codebook, regardless of how many HARQ processes are actually received by the terminal, the terminal will feed back ACK/NACK feedback information corresponding to the N processes to the base station. The ACK/NACK information is mapped to a feedback information codebook in an order of HARQ process identity (ID) firstly and then carrier ID. ACK/NACK information corresponding to a HARQ process not received is set to placeholder information (such as NACK). The structure of the Type-3 HARQ-ACK codebook will be illustrated below by taking FIG. 2 as an example. It is assumed that the terminal is configured with three cells (carriers) for data transmission, where cell 1 supports up to eight HARQ processes, cell 2 supports up to four HARQ processes, and cell 3 supports up to sixteen HARQ processes. The maximum number of codewords supported by each cell is one, that is, only one transport block (TB) is carried on each PDSCH, and corresponds to one bit of ACK/NACK feedback information. In an implementation, the feedback codebook includes {b_{1,1}, . . . , b_{1,8}, b_{2,1}, . . . , b_{2,4}, b_{3,1}, . . . , b_{3,16}}, where b_{i,j} represents ACK/NACK feedback information corresponding to HARQ process j in cell i. In another implementation, the feedback codebook includes {b_{1,1}, NDI_{1,1}, . . . , b_{1,8}, NDI_{1,8}, b_{2,1}, NDI_{2,1}, . . . , b_{2,4}, NDI_{2,4}, b_{3,1}, NDI_{3,1}, . . . , b_{3,16}, NDI_{3,16}}, where b_{i,j} represents ACK/NACK feedback information corresponding to HARQ process j in cell i, and NDI_{i,j} represents new data indicator (NDI) information corresponding to HARQ process j that is last received by the terminal in cell i.

Furthermore, the NR system supports an enhanced Type-3 (eType-3) HARQ-ACK feedback codebook, i.e. an eType-3 codebook, which is intended for reducing feedback overhead, that is, the base station may trigger the terminal to feed back feedback information corresponding to some of the HARQ processes. Specifically, several cell sets or HARQ process sets are preconfigured via higher-layer signaling, where each set includes some cells or HARQ processes, and the terminal is triggered by DCI signaling to feed back feedback information corresponding to a certain set in the preconfigured sets. Taking FIG. 2 as an example, four cell sets are preconfigured via higher-layer signaling, as shown in table 1. If DCI trigger signaling indicates set 3, a feedback codebook to be transmitted by the terminal is {b_{2,1}, . . . , b_{2,4}, b_{3,1}, . . . , b_{3,16}}, where b_{i,j} represents ACK/NACK feedback information corresponding to HARQ process j in cell i. Table 2 gives an example of HARQ process set configurations, and for details thereof, reference can be made to the example of cell sets, which will not be described in further detail herein.

TABLE 1
Cell set

| | |
|---|---|
| Cell set 1 | Cell 1 |
| Cell set 2 | Cell 1 and cell 2 |
| Cell set 3 | Cell 2 and cell 3 |
| Cell set 4 | Cell 1, cell 2, and cell 3 |

TABLE 2
HARQ process set

| | |
|---|---|
| HARQ process set 1 | HARQ processes 1~4 in cell 1, HARQ |
| | processes 1~4 in cell 2, and HARQ processes |
| | 1~4 in cell 3 |
| HARQ process set 2 | HARQ processes 5~8 in cell 1, and HARQ |
| | processes 5~8 in cell 3 |
| HARQ process set 3 | HARQ processes 9~16 in cell 3 |
| HARQ process set 4 | All HARQ processes in cell 1, cell 2, and cell 3 |

In order to better support ultra-reliable low-latency communication (URLLC) services, subslot-based ACK/NACK feedback is supported, that is, a time interval for ACK/NACK feedback is determined at a granularity of subslot, and a physical uplink control channel (PUCCH) carrying the ACK/NACK is transmitted in one subslot, where the subslot may be two symbols or seven symbols. In addition, a physical channel may be configured with 2-level priority, namely high priority (HP) or low priority (LP). A granularity for ACK/NACK feedback corresponding to an HP service and a granularity for ACK/NACK feedback corresponding to an LP service may be separately configured, for example, subslot-based feedback may be adopted for ACK/NACK for an HP service, while slot-based feedback may be adopted for ACK/NACK for an LP service. For a delay-sensitive URLLC service, a subslot-based ACK/NACK feedback may be configured and the service may be indicated as HP.

In order for better understanding of embodiments of the disclosure, the problems that the disclosure is intended to solve will be described below.

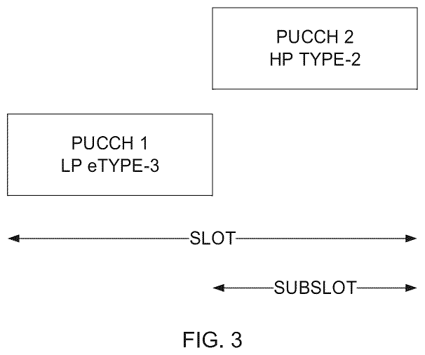

Since a Type-3/eType-3 codebook is dynamically triggered by the base station and feedback information carried therein is complete, the terminal does not expect that ACK/NACK information carried in other Type-1/Type-2 codebooks to be transmitted is not contained in an eType-3 codebook in a time unit in which a PUCCH for transmitting the eType-3 codebook is located. However, if a PUCCH carrying an eType-3 codebook and a PUCCH carrying a Type-1/Type-2 codebook correspond to different time domain granularities respectively (for example, one is slot and the other is subslot), the above proposal will cause unnecessary restrictions. Taking FIG. 3 as an example, an LP eType-3 codebook is to be transmitted on a slot-based PUCCH, and an HP Type-2 codebook is to be transmitted on a subslot-based PUCCH, where the two channels do not overlap with each other, and accordingly, the terminal will transmit PUCCH 1 and PUCCH 2 in a slot. According to the restrictions of the above proposal, all ACK/NACK information in the HP Type-2 codebook needs to be contained in the LP eType-3 codebook, and the feedback information will be transmitted twice, which will cause redundancy in transmission, thus reducing uplink efficiency and increasing power consumption of the terminal. On the other hand, in order to ensure that the LP eType-3 codebook contains all the ACK/NACK information in the HP Type-2 codebook, trigger signaling needs to indicate a large cell set or HARQ process set, which results in additional feedback overhead, thus reducing uplink efficiency and increasing power consumption of the terminal.

In view of the above problem, the disclosure provides a feedback scheme. If a Type-3/eType-3 codebook and a Type-1/Type-2 codebook need to be transmitted at the same time, feedback information in the Type-1/Type-2 codebook can be mapped to the Type-3/eType-3 codebook, which reduces feedback overhead and improve uplink transmission efficiency.

Technical solutions of the disclosure will be described in detail below with reference to embodiments.

A wireless communication method, a terminal device, and a network device are provided. If a first feedback codebook and a second feedback codebook are configured to be transmitted in the same time unit, feedback information in the second feedback codebook can be mapped to the first feedback codebook, and as such, the terminal device does not have to transmit the second feedback codebook, thereby reducing feedback overhead and improving uplink transmission efficiency.

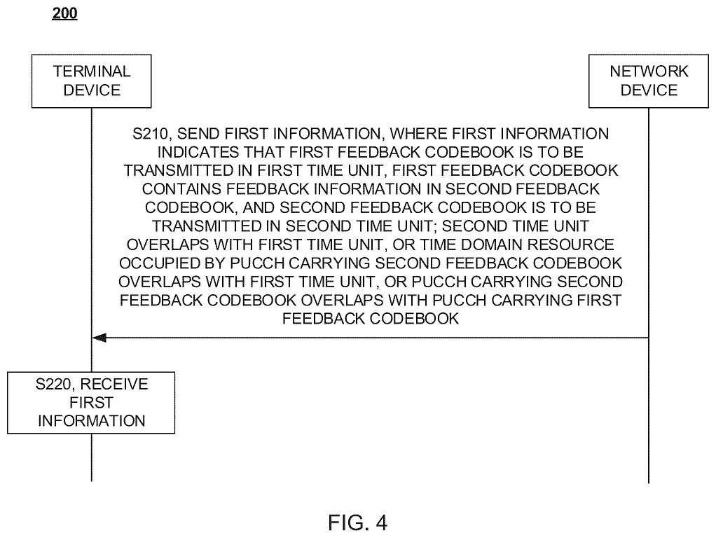

FIG. 4 is a schematic flowchart of a wireless communication method 200 according to embodiments of the disclosure. As illustrated in FIG. 4, the method 200 may include at least some of the following.

S210, a network device sends first information to a terminal device. The first information indicates that a first feedback codebook is to be transmitted in a first time unit, where the first feedback codebook contains feedback information in a second feedback codebook, and the second feedback codebook is to be transmitted in a second time unit. The second time unit overlaps with the first time unit, or a time domain resource occupied by a PUCCH carrying the second feedback codebook overlaps with the first time unit, or the PUCCH carrying the second feedback codebook overlaps with a PUCCH carrying the first feedback codebook.

S220, the terminal device receives the first information.

In embodiments of the disclosure, if the second time unit overlaps with the first time unit, the first feedback codebook may contain the feedback information in the second feedback codebook. Alternatively, if the time domain resource occupied by the PUCCH carrying the second feedback codebook overlaps with the first time unit, the first feedback codebook may contain the feedback information in the second feedback codebook. Alternatively, if the PUCCH carrying the second feedback codebook overlaps with the PUCCH carrying the first feedback codebook, the first feedback codebook may contain the feedback information in the second feedback codebook. That is, if the first feedback codebook and the second feedback codebook are configured to be transmitted in the same time unit, the feedback information in the second feedback codebook can be mapped to the first feedback codebook, and in this way, the terminal device does not have to transmit the second feedback codebook, thereby reducing feedback overhead and improving uplink transmission efficiency.

In other words, in embodiments of the disclosure, if the second time unit overlaps with the first time unit, the terminal device does not expect that the feedback information in the second feedback codebook cannot be mapped to the first feedback codebook, that is, the terminal device expects that the feedback information in the second feedback codebook can be mapped to the first feedback codebook. Alternatively, if the time domain resource occupied by the PUCCH carrying the second feedback codebook overlaps with the first time unit, the terminal device does not expect that the feedback information in the second feedback codebook cannot be mapped to the first feedback codebook, that is, the terminal device expects that the feedback information in the second feedback codebook can be mapped to the first feedback codebook. Alternatively, if the PUCCH carrying the second feedback codebook overlaps with the PUCCH carrying the first feedback codebook, the terminal device does not expect that the feedback information in the second feedback codebook cannot be mapped to the first feedback codebook, that is, the terminal device expects that the feedback information in the second feedback codebook can be mapped to the first feedback codebook.

In embodiments of the disclosure, “the second time unit overlaps with the first time unit” may mean that the second time unit partially overlaps with the first time unit, or the second time unit fully overlaps with the first time unit. Similarly, “the time domain resource occupied by the PUCCH carrying the second feedback codebook overlaps with the first time unit” may mean that the time domain resource occupied by the PUCCH carrying the second feedback codebook partially overlaps with the first time unit, or the time domain resource occupied by the PUCCH carrying the second feedback codebook fully overlaps with the first time unit. Similarly, “the PUCCH carrying the second feedback codebook overlaps with the PUCCH carrying the first feedback codebook” may mean that the PUCCH carrying the second feedback codebook partially overlaps with the PUCCH carrying the first feedback codebook, or the PUCCH carrying the second feedback codebook fully overlaps with the PUCCH carrying the first feedback codebook.

In some embodiments, the first feedback codebook is a Type-3 codebook, or the first feedback codebook is an eType-3 codebook.

In some embodiments, the second feedback codebook is a Type-1 codebook, or the second feedback codebook is a Type-2 codebook.

In some embodiments, the PUCCH carrying the first feedback codebook is to be transmitted in the first time unit, and the PUCCH carrying the second feedback codebook is to be transmitted in the second time unit.

In some embodiments, the first time unit and the second time unit are different in length.

For example, the length of the first time unit is one of: a slot, a subslot, or N symbols; and/or the length of the second time unit is one of: a slot, a subslot, or M symbols, where N and M each are a positive integer.

For example, the length of the first time unit is one slot, and the length of the second time unit is one subslot.

For another example, the length of the first time unit is one subslot, and the length of the second time unit is one slot.

For another example, the length of the first time unit is N symbols, and the length of the second time unit is M symbols.

It should be noted that, each subslot may include two symbols or seven symbols.

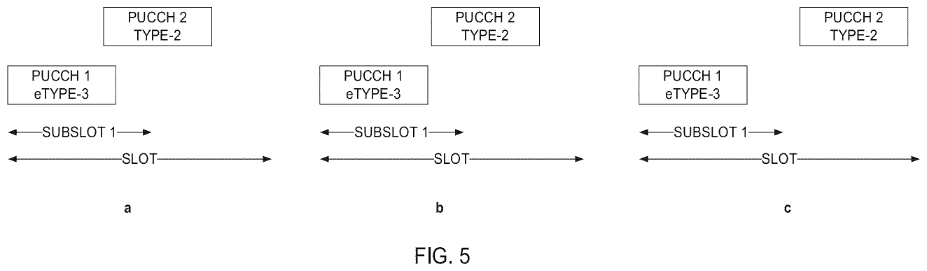

Example 1: we have the following assumptions: “the second time unit overlaps with the first time unit” is condition 1, “the time domain resource occupied by the PUCCH carrying the second feedback codebook overlaps with the first time unit” is condition 2, and “the PUCCH carrying the second feedback codebook overlaps with the PUCCH carrying the first feedback codebook” is condition 3; the first feedback codebook is an eType-3 codebook, and the second feedback codebook is a Type-2 codebook. For example, as illustrated in FIG. 5, the network device instructs the terminal device to transmit a subslot-based eType-3 codebook and a slot-based Type-2 codebook in a slot. That is, the eType-3 codebook is to be transmitted in a subslot (namely, subslot 1 in the slot illustrated in FIG. 5), and the Type-2 codebook is to be transmitted in a slot.

In example 1, under condition 1, for a˜c in FIG. 5, because the slot occupied by the Type-2 codebook overlaps with subslot 1, the eType-3 codebook needs to contain all ACK/NACK information in the Type-2 codebook.

In example 1, under condition 2, for a and b in FIG. 5, because PUCCH 2 carrying the Type-2 codebook overlaps with subslot 1, the eType-3 codebook needs to contain all ACK/NACK information in the Type-2 codebook; for c in FIG. 5, because PUCCH 2 carrying the Type-2 codebook does not overlap with subslot 1, the eType-3 codebook does not have to contain all ACK/NACK information in the Type-2 codebook.

In example 1, under condition 3, for a in FIG. 5, because PUCCH 2 carrying the Type-2 codebook overlaps with PUCCH 1, the eType-3 codebook needs to contain all ACK/NACK information in the Type-2 codebook; for b and c in FIG. 5, because PUCCH 2 carrying the Type-2 codebook does not overlap with PUCCH 1, the eType-3 codebook does not have to contain all ACK/NACK information in the Type-2 codebook.

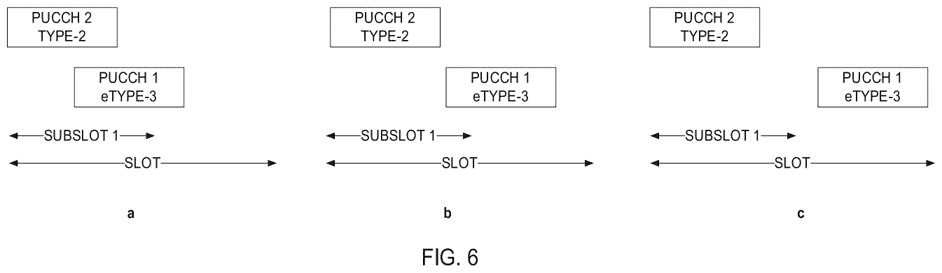

Example 2: we have the following assumptions: “the second time unit overlaps with the first time unit” is condition 1, “the time domain resource occupied by the PUCCH carrying the second feedback codebook overlaps with the first time unit” is condition 2, and “the PUCCH carrying the second feedback codebook overlaps with the PUCCH carrying the first feedback codebook” is condition 3; the first feedback codebook is an eType-3 codebook, and the second feedback codebook is a Type-2 codebook. For example, as illustrated in FIG. 6, the network device instructs the terminal device to transmit a slot-based eType-3 codebook and a subslot-based Type-2 codebook in a slot. That is, the Type-2 codebook is to be transmitted in a subslot (namely, subslot 1 in the slot illustrated in FIG. 6), and the eType-3 codebook is to be transmitted in a slot.

In example 2, under condition 1, for a˜c in FIG. 6, because subslot 1 occupied by the Type-2 codebook overlaps with the slot, the eType-3 codebook needs to contain all ACK/NACK information in the Type-2 codebook.

In example 2, under condition 2, for a˜c in FIG. 6, because the PUCCH carrying the Type-2 codebook overlaps with the slot, the eType-3 codebook needs to contain all ACK/NACK information in the Type-2 codebook.

In example 2, under condition 3, for a in FIG. 6, because PUCCH 2 carrying the Type-2 codebook overlaps with PUCCH 1, the eType-3 codebook needs to contain all ACK/NACK information in the Type-2 codebook; for b and c in FIG. 6, because PUCCH 2 carrying the Type-2 codebook does not overlap with PUCCH 1, the eType-3 codebook does not have to contain all ACK/NACK information in the Type-2 codebook.

In some embodiments, the first feedback codebook contains feedback information corresponding to a HARQ process in a first cell set, and the first cell set includes at least one cell configured for the terminal device.

It should be noted that, the first cell set may be a cell set in at least one cell set configured for the terminal device.

In some embodiments, the first feedback codebook contains feedback information corresponding to a HARQ process in a first HARQ process set, and the first HARQ process set includes at least one HARQ process configured for the terminal device.

It should be noted that, the first HARQ process set may be a HARQ process set in at least one HARQ process set configured for the terminal device.

In some embodiments, the HARQ process configured for the terminal device includes at least one HARQ process for at least one cell configured for the terminal device.

In some embodiments, the first feedback codebook containing the feedback information in the second feedback codebook includes the following: the first feedback codebook includes all information bits in the second feedback codebook. That is, all the information bits in the second feedback codebook may be mapped to the first feedback codebook.

In some embodiments, the first feedback codebook containing the feedback information in the second feedback codebook includes the following: the first feedback codebook contains feedback information corresponding to a HARQ process corresponding to the information bit in the second feedback codebook. That is, information to be mapped to the first feedback codebook may be only the feedback information corresponding to the HARQ process corresponding to the information bit in the second feedback codebook.

In some embodiments, the first feedback codebook containing the feedback information in the second feedback codebook includes the following: the first feedback codebook contains first feedback information in the second feedback codebook, where the first feedback information is feedback information corresponding to a first downlink channel, and whether a transmission location of the first feedback information is in the second time unit is determined according to a preconfigured feedback time and a third time unit in which an ending symbol for the first downlink channel is located. That is, information to be mapped to the first feedback codebook may be only the first feedback information in the second feedback codebook. Optionally, the feedback time may be indicated by the network device via DCI or higher-layer signaling. The feedback time may also be specified a protocol, and the disclosure is not limited in this regard.

For example, if the ending symbol for the first downlink channel is in time unit n and the DCI or the higher-layer signaling indicates k1 (that is, the preconfigured feedback time is k1), the feedback information corresponding to the first downlink channel is to be transmitted in time unit n+k1.

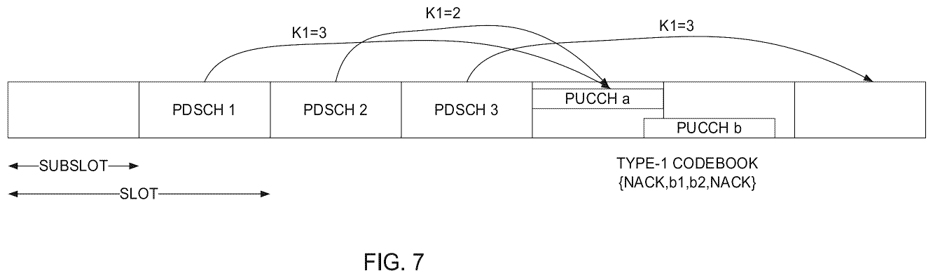

Example 3: we have the following assumptions: “the first feedback codebook includes all the information bits in the second feedback codebook” is mode A, “the first feedback codebook contains the feedback information corresponding to the HARQ process corresponding to the information bit in the second feedback codebook” is mode B, and “the first feedback codebook contains the first feedback information in the second feedback codebook” is mode C; the first feedback codebook is an eType-3 codebook, and the second feedback codebook is a Type-1 codebook. Specifically, it is determined, according to a preconfigured set of feedback times K1 {1,2,3,4}, that the Type-1 codebook to be transmitted in subslot n+4 contains four bits of feedback information, where the four bits correspond to subslot n˜subslot n+3 respectively. In subslot n, no PDSCH is received, and accordingly, a corresponding bit in the Type-1 codebook in subslot n+4 is set to NACK. A PDSCH received in subslot n+1 carries HARQ process X, and a corresponding feedback time k1=3, that is, corresponding feedback information is to be transmitted in the Type-1 codebook (carried on PUCCH a) in subslot n+4, and a corresponding bit is set to ACK or NACK according to a decoding result. Similarly, PDSCH 2 carries HARQ process Y, and corresponding feedback information is also to be transmitted in the Type-1 codebook (carried on PUCCH a) in subslot n+4, and a corresponding bit is set to ACK or NACK according to a decoding result. PDSCH 3 carries HARQ process Z. Although subslot n+3 is occupied for transmission, that is, the Type-1 codebook in subslot n+4 includes a corresponding bit, it is determined, according to feedback time k1, that corresponding feedback information is to be transmitted in subslot n+6, and therefore, the corresponding bit in the Type-1 codebook in subslot n+4 is set to NACK, as illustrated in FIG. 7.

In example 3, in mode A, if a slot-based eType-3 codebook is triggered by a base station and a slot in which the eType-3 codebook is located overlaps with subslot n+4, the eType-3 codebook needs to contain feedback information corresponding to HARQ process X carried on PDSCH 1, feedback information corresponding to HARQ process Y carried on PDSCH 2, and feedback information corresponding to HARQ process Z carried on PDSCH 3. However, the feedback information corresponding to HARQ process Z carried on PDSCH 3 is set to NACK, which is the same as the information in the Type-1 codebook.

In example 3, there is a bit corresponding to subslot n+3 in the Type-1 codebook, i.e. a bit corresponding to PDSCH 3, although there is no valid feedback information. In mode B, if a slot-based eType-3 codebook is triggered by a base station and a slot in which the eType-3 codebook is located overlaps with subslot n+4, the eType-3 codebook needs to contain feedback information corresponding to HARQ process X carried on PDSCH 1, feedback information corresponding to HARQ process Y carried on PDSCH 2, and feedback information corresponding to HARQ process Z carried on PDSCH 3. In this case, the feedback information corresponding to HARQ process Z is set according to a decoding result of HARQ process Z, that is, the information corresponding to HARQ process Z is not necessarily set to NACK. In addition, if PDSCH 3 satisfies a processing delay, i.e. an interval between an ending location of PDSCH 3 and a starting location of PUCCH b is not less than a predefined value, the feedback information corresponding to HARQ process Z will be set according to the decoding result.

In example 3, in mode C, if a slot-based eType-3 codebook is triggered by a base station and a slot in which the eType-3 codebook is located overlaps with subslot n+4, the eType-3 codebook needs to contain feedback information corresponding to HARQ process X carried on PDSCH 1 and feedback information corresponding to HARQ process Y carried on PDSCH 2, but there is no limitation on whether the eType-3 codebook contains feedback information corresponding to HARQ process Z carried on PDSCH 3.

In some embodiments, the first information may be carried in one of: DCI, radio resource control (RRC) signaling, or a media access control-control element (MAC CE).

Therefore, in embodiments of the disclosure, if the second time unit overlaps with the first time unit, the first feedback codebook may contain the feedback information in the second feedback codebook. Alternatively, if the time domain resource occupied by the PUCCH carrying the second feedback codebook overlaps with the first time unit, the first feedback codebook may contain the feedback information in the second feedback codebook. Alternatively, if the PUCCH carrying the second feedback codebook overlaps with the PUCCH carrying the first feedback codebook, the first feedback codebook may contain the feedback information in the second feedback codebook. That is, if the first feedback codebook and the second feedback codebook are configured to be transmitted in the same time unit, the feedback information in the second feedback codebook can be mapped to the first feedback codebook, and in this way, the terminal device does not have to transmit the second feedback codebook, thereby reducing feedback overhead and improving uplink transmission efficiency.

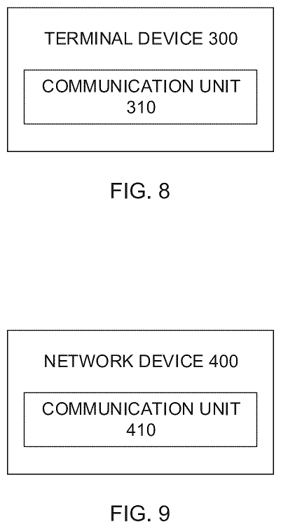

The method embodiments of the disclosure are described in detail above with reference to FIG. 4 to FIG. 7, and apparatus embodiments of the disclosure will be described in detail below with reference to FIG. 8 to FIG. 9. It should be understood that, apparatus embodiments and method embodiments correspond to each other, and for similar illustration, reference can be made to the method embodiments.

FIG. 8 is a schematic block diagram of a terminal device 300 according to embodiments of the disclosure. As illustrated in FIG. 8, the terminal device 300 includes a communication unit 310. The communication unit 310 is configured to receive first information. The first information indicates that a first feedback codebook is to be transmitted in a first time unit, the first feedback codebook contains feedback information in a second feedback codebook, and the second feedback codebook is to be transmitted in a second time unit. The second time unit overlaps with the first time unit, or a time domain resource occupied by a PUCCH carrying the second feedback codebook overlaps with the first time unit, or the PUCCH carrying the second feedback codebook overlaps with a PUCCH carrying the first feedback codebook.

In some embodiments, the PUCCH carrying the first feedback codebook is to be transmitted in the first time unit, and the PUCCH carrying the second feedback codebook is to be transmitted in the second time unit.

In some embodiments, the first time unit and the second time unit are different in length.

In some embodiments, the length of the first time unit is one of: a length of the first time unit is one of: a slot, a subslot, or N symbols; and/or a length of the second time unit is one of: a slot, a subslot, or M symbols, where N and M each are a positive integer.

In some embodiments, the first feedback codebook contains feedback information corresponding to a HARQ process in a first cell set, and the first cell set includes at least one cell configured for the terminal device. Alternatively, the first feedback codebook contains feedback information corresponding to a HARQ process in a first HARQ process set, and the first HARQ process set includes at least one HARQ process configured for the terminal device.

In some embodiments, the HARQ process configured for the terminal device includes at least one HARQ process for at least one cell configured for the terminal device.

In some embodiments, the first feedback codebook containing feedback information in the second feedback codebook includes the following. The first feedback codebook includes all information bits in the second feedback codebook. Alternatively, the first feedback codebook contains feedback information corresponding to a HARQ process corresponding to the information bit in the second feedback codebook. Alternatively, the first feedback codebook contains first feedback information in the second feedback codebook, where the first feedback information is feedback information corresponding to a first downlink channel, and whether a transmission location of the first feedback information is in the second time unit is determined according to a preconfigured feedback time and a third time unit in which an ending symbol for the first downlink channel is located.

In some embodiments, the first feedback codebook is a Type-3 codebook, or the first feedback codebook is an eType-3 codebook.

In some embodiments, the second feedback codebook is a Type-1 codebook, or the second feedback codebook is a Type-2 codebook.

In some embodiments, the communication unit may be a communication interface or a transceiver, or an input/output interface of a communication chip or an SoC.

It should be understood that, the terminal device 300 according to embodiments of the disclosure may correspond to the terminal device in the method embodiments of the disclosure, and the foregoing and other operations and/or functions of various units in the terminal device 300 are respectively intended to implement corresponding procedures performed by the terminal device in the method 200 illustrated in FIG. 4, which will not be described again herein for the sake of brevity.

FIG. 9 is a schematic block diagram of a network device 400 according to embodiments of the disclosure. As illustrated in FIG. 9, the network device 400 includes a communication unit 410. The communication unit 410 is configured to send first information to a terminal device. The first information indicates that a first feedback codebook is to be transmitted in a first time unit, the first feedback codebook contains feedback information in a second feedback codebook, and the second feedback codebook is to be transmitted in a second time unit. The second time unit overlaps with the first time unit, or a time domain resource occupied by a PUCCH carrying the second feedback codebook overlaps with the first time unit, or the PUCCH carrying the second feedback codebook overlaps with a PUCCH carrying the first feedback codebook.

In some embodiments, the PUCCH carrying the first feedback codebook is to be transmitted in the first time unit, and the PUCCH carrying the second feedback codebook is to be transmitted in the second time unit.

In some embodiments, the first time unit and the second time unit are different in length.

In some embodiments, a length of the first time unit is one of: a slot, a subslot, or N symbols; and/or a length of the second time unit is one of: a slot, a subslot, or M symbols, where N and M each are a positive integer.

In some embodiments, the first feedback codebook contains feedback information corresponding to a HARQ process in a first cell set, and the first cell set includes at least one cell configured for the terminal device. Alternatively, the first feedback codebook contains feedback information corresponding to a HARQ process in a first HARQ process set, and the first HARQ process set includes at least one HARQ process configured for the terminal device.

In some embodiments, the HARQ process configured for the terminal device includes at least one HARQ process for at least one cell configured for the terminal device.

In some embodiments, the first feedback codebook containing feedback information in the second feedback codebook includes the following. The first feedback codebook includes all information bits in the second feedback codebook. Alternatively, the first feedback codebook contains feedback information corresponding to a HARQ process corresponding to the information bit in the second feedback codebook. Alternatively, the first feedback codebook contains first feedback information in the second feedback codebook, where the first feedback information is feedback information corresponding to a first downlink channel, and whether a transmission location of the first feedback information is in the second time unit is determined according to a preconfigured feedback time and a third time unit in which an ending symbol for the first downlink channel is located.

In some embodiments, the first feedback codebook is a Type-3 codebook, or the first feedback codebook is an eType-3 codebook.

In some embodiments, the second feedback codebook is a Type-1 codebook, or the second feedback codebook is a Type-2 codebook.

In some embodiments, the communication unit may be a communication interface or a transceiver, or an input/output interface of a communication chip or an SoC.

It should be understood that, the network device 400 according to embodiments of the disclosure may correspond to the network device in the method embodiments of the disclosure, and the foregoing and other operations and/or functions of various units in the network device 400 are respectively intended to implement corresponding procedures performed by the network device in the method 200 illustrated in FIG. 4, which will not be described again herein for the sake of brevity.

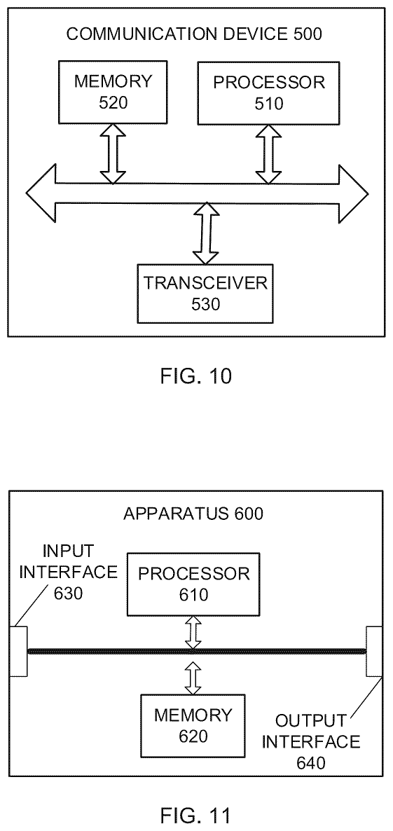

FIG. 10 is a schematic structural diagram of a communication device 500 according to embodiments of the disclosure. The communication device 500 illustrated in FIG. 10 includes a processor 510. The processor 510 can invoke and execute computer programs from a memory, so as to implement the method in embodiments of the disclosure.

In some embodiments, as illustrated in FIG. 10, the communication device 500 may further include a memory 520. The processor 510 can invoke and execute computer programs from the memory 520 to implement the method in embodiments of the disclosure.

The memory 520 may be a a separate device independent of the processor 510, may be integrated into the processor 510.

In some embodiments, as illustrated in FIG. 10, the communication device 500 may further include a transceiver 530. The processor 510 can control the transceiver 530 to communicate with other devices, and specifically, can send information or data to other devices, or receive information or data sent by other devices.

The transceiver 530 may include a transmitter and a receiver. The transceiver 530 can further include an antenna, where one or more antennas may be provided.

In some embodiments, the communication device 500 may specifically be the network device in embodiments of the disclosure, and the communication device 500 may implement corresponding procedures implemented by the network device in various methods in embodiments of the disclosure, which will not be described again herein for the sake of brevity.

In some embodiments, the communication device 500 may specifically be the terminal device in embodiments of the disclosure, and the communication device 500 may implement corresponding procedures implemented by the terminal device in various methods in embodiments of the disclosure, which will not be described again herein for the sake of brevity.

FIG. 11 is a schematic structural diagram of an apparatus according to embodiments of the disclosure. The apparatus 600 illustrated in FIG. 11 includes a processor 610. The processor 610 can invoke and execute computer programs from a memory, so as to implement the method in embodiments of the disclosure.

In some embodiments, as illustrated in FIG. 11, the apparatus 600 may further include a memory 620. The processor 610 may invoke and execute computer programs from the memory 620, so as to implement the method in embodiments of the disclosure.

The memory 620 may be a separate device independent of the processor 610, or may be integrated into the processor 610.

In some embodiments, the apparatus 600 may further include an input interface 630. The processor 610 can control the input interface 630 to communicate with other devices or chips, and specifically, can obtain information or data sent by other devices or chips.

In some embodiments, the apparatus 600 may further include an output interface 640. The processor 610 can control the output interface 640 to communicate with others device or chips, and specifically, can output information or data to other devices or chips.

In some embodiments, the apparatus may be applied to the network device in embodiments of the disclosure, and the apparatus may implement corresponding procedures implemented by the network device in various methods in embodiments of the disclosure, which will not be described again herein for the sake of brevity.

In some embodiments, the apparatus may be applied to the terminal device in embodiments of the disclosure, and the apparatus may implement corresponding procedures implemented by the terminal device in various methods in embodiments of the disclosure, which will not be described again herein for the sake of brevity.

In some embodiments, the apparatus described in embodiments of the disclosure may also be a chip, for example, an SoC or the like.

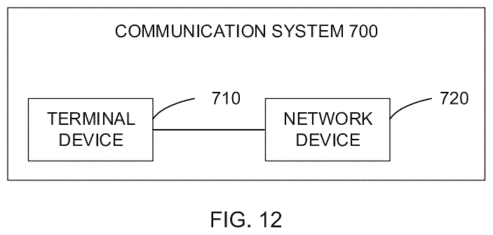

FIG. 12 is a schematic block diagram of a communication system 700 provided in embodiments of the disclosure. As illustrated in FIG. 12, the communication system 700 includes a terminal device 710 and a network device 720.

The terminal device 710 may be configured to implement corresponding functions implemented by the terminal device in the foregoing method, and the network device 720 may be configured to implement corresponding functions implemented by the network device in the foregoing method, which will not be described again herein for the sake of brevity.

It should be understood that, the processor in embodiments of the disclosure may be an integrated circuit chip with signal processing capabilities. During implementation, each step of the foregoing method embodiments may be completed by an integrated logic circuit of hardware in the processor or an instruction in the form of software. The processor may be a general-purpose processor, a digital signal processor (DSP), an ASIC, a field programmable gate array (FPGA), or other programmable logic devices, discrete gates or transistor logic devices, discrete hardware components. The methods, steps, and logic blocks disclosed in embodiments of the disclosure can be implemented or executed. The general-purpose processor may be a microprocessor, or the processor may be any conventional processor or the like. The steps of the method disclosed in embodiments of the disclosure may be directly implemented by a hardware decoding processor, or may be performed by hardware and software modules in the decoding processor. The software module can be located in a storage medium such as a random access memory (RAM), a flash memory, a read only memory (ROM), a programmable ROM (PROM), or an electrically erasable programmable memory, registers, and the like. The storage medium is located in the memory. The processor reads the information in the memory, and completes the steps of the method described above with the hardware thereof.

It can be understood that, the memory in embodiments of the disclosure may be a volatile memory or a non-volatile memory, or may include both the volatile memory and the non-volatile memory. The non-volatile memory may be a ROM, a PROM, an erasable PROM (EPROM), an electrically EPROM (EEPROM), or flash memory. The volatile memory can be a RAM that acts as an external cache. By way of example but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). It should be noted that, the memory of the systems and methods described in the disclosure is intended to include, but is not limited to, these and any other suitable types of memory.

It should be understood that, the memory above is intended for illustration rather than limitation. For example, the memory in embodiments of the disclosure may also be an SRAM, a DRAM, an SDRAM, a DDR SDRAM, an ESDRAM, an SLDRAM, a DR RAM, etc. In other words, the memory in embodiments of the disclosure is intended to include, but is not limited to, these and any other suitable types of memory.

Embodiments of the disclosure further provide a computer-readable storage medium. The computer-readable storage medium is configured to store computer programs.

In some embodiments, the computer-readable storage medium may be applied to the network device in embodiments of the disclosure, and the computer programs are operable with a computer to execute corresponding operations implemented by the network device in various methods in embodiments of the disclosure, which will not be described again herein for the sake of brevity.

In some embodiments, the computer-readable storage medium may be applied to the terminal device in embodiments of the disclosure, and the computer programs are operable with a computer to execute corresponding operations implemented by the terminal device in various methods in embodiments of the disclosure, which will not be described again herein for the sake of brevity.

Embodiment of the disclosure further provide a computer program product. The computer program product includes computer program instructions.

In some embodiments, the computer program product may be applied to the network device in embodiments of the disclosure, and the computer program instructions are operable with a computer to perform corresponding operations implemented by the network device in various methods in embodiments of the disclosure, which will not be described again herein for the sake of brevity.

In some embodiments, the computer program product may be applied to the terminal device in embodiments of the disclosure, and the computer program instructions are operable with a computer to perform corresponding operations implemented by the terminal device in various methods in embodiments of the disclosure, which will not be described again herein for the sake of brevity.

Embodiments of the disclosure further provide a computer program.

In some embodiments, the computer program may be applied to the network device in embodiments of the disclosure. The computer program, when executed by a computer, is operable to implement corresponding operations implemented by the network device in various methods in embodiments of the disclosure, which will not be described again herein for the sake of brevity.

In some embodiments, the computer program may be applied to the terminal device in embodiments of the disclosure. The computer program, when executed by a computer, is operable to implement corresponding operations implemented by the terminal device in various methods in embodiments of the disclosure, which will not be described again herein for the sake of brevity.

Those of ordinary skill in the art will appreciate that units and algorithmic operations of various examples described in connection with embodiments of the disclosure can be implemented by electronic hardware or by a combination of computer software and electronic hardware. Whether these functions are performed by means of hardware or software depends on the application and the design constraints of the associated technical solution. Those skilled in the art may use different methods with regard to each particular application to implement the described functionality, but such implementation should not be regarded as lying beyond the scope of the disclosure.

It will be evident to those skilled in the art that, for the sake of convenience and brevity, in terms of the working procedures of the foregoing systems, apparatuses, and units, reference can be made to the corresponding procedures in the foregoing method embodiments, which will not be described again herein.

It will be appreciated that the systems, apparatuses, and methods disclosed in embodiments of the disclosure may also be implemented in various other manners. For example, the above apparatus embodiments are merely illustrative, e.g., the division of units is only a division of logical functions, and other manners of division may be available in practice, e.g., multiple units or assemblies may be combined or may be integrated into another system, or some features may be ignored or skipped. In other respects, the coupling or direct coupling or communication connection as illustrated or discussed may be an indirect coupling or communication connection through some interface, device, or unit, and may be electrical, mechanical, or otherwise.

Separated units as illustrated may or may not be physically separated. Components displayed as units may or may not be physical units, and may reside at one location or may be distributed to multiple networked units. Some or all of the units may be selectively adopted according to practical needs to achieve desired objectives of the disclosure.

In addition, various functional units described in various embodiments of the disclosure may be integrated into one processing unit or may be present as a number of physically separated units, or two or more units may be integrated into one.

If the functions are implemented as software functional units and sold or used as standalone products, they may be stored in a computer-readable storage medium. Based on such an understanding, the essential technical solution, or the portion that contributes to the related art, or part of the technical solution of the disclosure may be embodied as software products. The computer software products can be stored in a storage medium and may include multiple instructions that, when executed, can cause a computer device, e.g., a personal computer, a server, a network device, etc., to execute some or all operations of the methods described in various embodiments of the disclosure. The above storage medium may include various kinds of media that can store program codes, such as a universal serial bus (USB) flash disk, a mobile hard drive, a ROM, a RAM, a magnetic disk, or an optical disk.

The foregoing elaborations are merely implementations of the disclosure, but are not intended to limit the protection scope of the disclosure. Any variation or replacement easily thought of by those skilled in the art within the technical scope disclosed in the disclosure shall belong to the protection scope of the disclosure. Therefore, the protection scope of the disclosure shall be subject to the protection scope of the claims.

I/we claim:

1. A wireless communication method, comprising:
receiving, by a terminal device, first information, wherein the first information indicates that a first feedback codebook is to be transmitted in a first time unit, the first feedback codebook contains feedback information in a second feedback codebook, and the second feedback codebook is to be transmitted in a second time unit; and
wherein the second time unit overlaps with the first time unit, or a time domain resource occupied by a physical uplink control channel (PUCCH) carrying the second feedback codebook overlaps with the first time unit, or the PUCCH carrying the second feedback codebook overlaps with a PUCCH carrying the first feedback codebook.

2. The method of claim 1, wherein:
the first feedback codebook contains feedback information corresponding to a hybrid automatic repeat request (HARQ) process in a first cell set, and the first cell set comprises at least one cell configured for the terminal device; or
the first feedback codebook contains feedback information corresponding to a HARQ process in a first HARQ process set, and the first HARQ process set comprises at least one HARQ process configured for the terminal device.

3. The method of claim 2, wherein the HARQ process configured for the terminal device comprises at least one HARQ process for at least one cell configured for the terminal device.

4. The method of claim 1, wherein the first feedback codebook containing the feedback information in the second feedback codebook comprises:
the first feedback codebook comprises all information bits in the second feedback codebook; or
the first feedback codebook contains feedback information corresponding to a HARQ process corresponding to the information bit in the second feedback codebook; or
the first feedback codebook contains first feedback information in the second feedback codebook, wherein the first feedback information is feedback information corresponding to a first downlink channel, and whether a transmission location of the first feedback information is in the second time unit is determined according to a preconfigured feedback time and a third time unit in which an ending symbol for the first downlink channel is located.

5. The method of claim 1, wherein the first feedback codebook is a Type-3 codebook, or the first feedback codebook is an enhanced Type-3 (eType-3) codebook.

6. The method of claim 1, wherein the second feedback codebook is a Type-1 codebook, or the second feedback codebook is a Type-2 codebook.

7. A terminal device, comprising:
a transceiver;
a memory configured to store computer programs; and
a processor configured to execute the computer programs stored in the memory, to cause the transceiver to:
receive first information, wherein the first information indicates that a first feedback codebook is to be transmitted in a first time unit, the first feedback codebook contains feedback information in a second feedback codebook, and the second feedback codebook is to be transmitted in a second time unit; and
wherein the second time unit overlaps with the first time unit, or a time domain resource occupied by a physical uplink control channel (PUCCH) carrying the second feedback codebook overlaps with the first time unit, or the PUCCH carrying the second feedback codebook overlaps with a PUCCH carrying the first feedback codebook.

8. The terminal device of claim 7, wherein:
the first feedback codebook contains feedback information corresponding to a hybrid automatic repeat request (HARQ) process in a first cell set, and the first cell set comprises at least one cell configured for the terminal device; or
the first feedback codebook contains feedback information corresponding to a HARQ process in a first HARQ process set, and the first HARQ process set comprises at least one HARQ process configured for the terminal device.

9. The terminal device of claim 8, wherein the HARQ process configured for the terminal device comprises at least one HARQ process for at least one cell configured for the terminal device.

10. The terminal device of claim 7, wherein the first feedback codebook containing the feedback information in the second feedback codebook comprises:
the first feedback codebook comprises all information bits in the second feedback codebook; or
the first feedback codebook contains feedback information corresponding to a HARQ process corresponding to the information bit in the second feedback codebook; or
the first feedback codebook contains first feedback information in the second feedback codebook, wherein the first feedback information is feedback information corresponding to a first downlink channel, and whether a transmission location of the first feedback information is in the second time unit is determined according to a preconfigured feedback time and a third time unit in which an ending symbol for the first downlink channel is located.

11. The terminal device of claim 7, wherein the first feedback codebook is a Type-3 codebook, or the first feedback codebook is an enhanced Type-3 (eType-3) codebook.

12. The terminal device of claim 7, wherein the second feedback codebook is a Type-1 codebook, or the second feedback codebook is a Type-2 codebook.

13. A network device, comprising:
a transceiver;
a memory configured to store computer programs; and
a processor configured to execute the computer programs stored in the memory, to cause the transceiver to:
send first information to a terminal device, wherein the first information indicates that a first feedback codebook is to be transmitted in a first time unit, the first feedback codebook contains feedback information in a second feedback codebook, and the second feedback codebook is to be transmitted in a second time unit; and
wherein the second time unit overlaps with the first time unit, or a time domain resource occupied by a physical uplink control channel (PUCCH) carrying the second feedback codebook overlaps with the first time unit, or the PUCCH carrying the second feedback codebook overlaps with the PUCCH carrying the first feedback codebook.

14. The network device of claim 13, wherein:
the first feedback codebook contains feedback information corresponding to a hybrid automatic repeat request (HARQ) process in a first cell set, and the first cell set comprises at least one cell configured for the terminal device; or
the first feedback codebook contains feedback information corresponding to a HARQ process in a first HARQ process set, and the first HARQ process set comprises at least one HARQ process configured for the terminal device.

15. The network device of claim 14, wherein the HARQ process configured for the terminal device comprises at least one HARQ process for at least one cell configured for the terminal device.

16. The network device of claim 13, wherein the first feedback codebook containing the feedback information in the second feedback codebook comprises:
the first feedback codebook comprises all information bits in the second feedback codebook; or
the first feedback codebook contains feedback information corresponding to a HARQ process corresponding to the information bit in the second feedback codebook; or
the first feedback codebook contains first feedback information in the second feedback codebook, wherein the first feedback information is feedback information corresponding to a first downlink channel, and whether a transmission location of the first feedback information is in the second time unit is determined according to a preconfigured feedback time and a third time unit in which an ending symbol for the first downlink channel is located.

17. The network device of claim 13, wherein the first feedback codebook is a Type-3 codebook, or the first feedback codebook is an enhanced Type-3 (eType-3) codebook.

18. The network device of claim 13, wherein the second feedback codebook is a Type-1 codebook, or the second feedback codebook is a Type-2 codebook.
